(19) United States
(12) Patent Application Publication
(10) Pub. No.: US 2014/0265017 A1
(43) Pub. Date: Sep. 18, 2014

(54) GOLF BALL MANUFACTURING METHOD

(71) Applicant: BRIDGESTONE SPORTS CO., LTD., Tokyo (JP)

(72) Inventors: Hiroyuki NAGASAWA, Chichibushi (JP); Katsunobu MOCHIZUKI, Chichibushi (JP)

(73) Assignee: BRIDGESTONE SPORTS CO., LTD., Tokyo (JP)

(21) Appl. No.: 13/845,672

(22) Filed: Mar. 18, 2013

(51) Int. Cl. B29D 99/00

(52) U.S. Cl. CPC B29D 99/0042
USPC 264/255

(57) ABSTRACT

The invention provides a method of manufacturing golf balls by drying blending:
one or more type of (i) resin pellets of a first kind obtained by kneading, in a nitrogen atmosphere, a low-humidity atmosphere having a moisture content of not more than 100 ppm or a vacuum atmosphere, a resin blend composed primarily of (A) a thermoplastic polyurethane and (B) a polyisocyanate compound, at least some of the isocyanate groups within the resin pellets remaining in an unreacted state; and
one or more type of (ii) resin pellets of a second kind composed primarily of (C) a thermoplastic polyurethane, then feeding the dry blend to an injection-molding operation and forming at least one cover layer.

### BACKGROUND OF THE INVENTION

The present invention relates to a method of manufacturing golf balls in which a thermoplastic polyurethane material is used as the cover stock. More specifically, the invention relates to a golf ball manufacturing method that excels in terms of the production costs and the supply stability of the starting materials.

The use of polyurethane materials as the cover stock for golf balls in recent years has drawn attention. Polyurethane materials, from the standpoint of the molding methods used to obtain moldings therefrom, are broadly divided into thermoset polyurethane materials and thermoplastic polyurethane materials. Moldings of the former—thermoset polyurethane materials—can be obtained by mixing a urethane prepolymer having isocyanate end groups with a polyol or polyamine curing agent in the form of a liquid starting material, pouring the resulting mixture directly into a mold, then heating and thereby triggering a urethane curing reaction.

Numerous golf balls that use such thermoset polyurethane materials have been disclosed in the art, such as those described in U.S. Pat. No. 5,334,673 (Patent Document 1), U.S. Pat. No. 6,117,024 (Patent Document 2), and U.S. Pat. No. 6,190,268 (Patent Document 3). Methods of molding thermoset polyurethane materials are disclosed in, for example, U.S. Pat. No. 5,006,297 (Patent Document 4), U.S. Pat. No. 5,733,428 (Patent Document 5), U.S. Pat. No. 5,888,437 (Patent Document 6), U.S. Pat. No. 5,897,884 (Patent Document 7) and U.S. Pat. No. 5,947,843 (Patent Document 8).

Moldings of thermoset polyurethane material have no plasticity when heated, and so the starting materials and molded articles made therewith cannot be recycled. Moreover, with regard to moldings of thermoset polyurethane materials, because the heating and curing step and the cooling step take a long time and also because the starting materials have a high reactivity when heated and are thus unstable, which makes the molding time very difficult to control, the productivity of such materials when applied to special moldings such as golf ball covers (moldings which encase a core material) is regarded as inefficient.

By contrast, moldings composed of thermoplastic polyurethane materials are not obtained by directly reacting the starting materials; instead, linear polyurethane materials synthesized by employing starting materials and a manufacturing method which differ somewhat from the above-described thermoset polyurethane materials are used in molding. Such polyurethane materials are thermoplastic; thermoplasticized polyurethane materials have the quality of hardening when cooled. Therefore, such polyurethane materials can be molded using an injection molding machine. When injection molding a thermoplastic polyurethane material, because the molding time is very short compared with the molding time for a thermoset polyurethane material and because injection molding is suitable for precision molding, this molding method is ideal for a golf ball cover. Moreover, thermoplastic polyurethane materials are recyclable, and thus easy on the global environment. Golf balls which use thermoplastic polyurethane materials are disclosed in, for example, U.S. Pat. No. 3,395,109 (Patent Document 9), U.S. Pat. No. 4,248,432 (Patent Document 10) and U.S. Pat. No. 4,442,282 (Patent Document 11).

However, golf ball covers which use conventional thermoplastic polyurethane materials leave something to be desired with regard to all of the following: the feel of the ball at impact, controllability, rebound, and scuff resistance on shots with an iron.

To address this problem, JP-A 9-271538 (Patent Document 12) describes a golf ball cover which uses a thermoplastic polyurethane material having a high resilience. Yet, even this golf ball cover falls short in terms of scuff resistance on shots with an iron.

JP-A 11-178949 (Patent Document 13) describes a golf ball cover which is composed primarily of the product obtained by reacting a thermoplastic polyurethane material with an isocyanate compound and has a relatively good scuff resistance on shots with an iron. In this cover, an isocyanate compound which is a blocked diisocyanate or an isocyanate dimer is added as an additive to the thermoplastic polyurethane material. By adding this isocyanate compound during melt mixture under applied heat using an extruder or during injection molding, a reaction is induced during molding.

However, in the molding of the cover in JP-A 11-178949 above, the isocyanate compound is prone to deactivation by moisture and thus difficult to handle, making it hard to obtain a stable reaction product. Also, blocked isocyanates, which are strongly hygroscopic, emit a strong blocking agent odor when they dissociate under the effect of heat, and thus are unsuitable for molding covers. In addition, when the isocyanate compound is in a powder or liquid form, controlling the amount of addition to the thermoplastic polyurethane material is difficult, which in turn has made it difficult to control the physical properties of the cover. Moreover, owing to the difference in the melting points of the thermoplastic polyurethane material and the isocyanate compound and the difference in their melt viscosities, slippage arises within the molding machine, which sometimes makes thorough blending impossible to achieve. In the foregoing published art, due to the above causes, the cover stock is affected by moisture and control of the additive loadings in the cover stock is inadequate. As a result, it has not been possible to obtain a golf ball cover which is fully satisfactory in terms of improving scuff resistance.

Also, the preferred thermoplastic polyurethane material mentioned in JP-A 11-178949 above is based on an aliphatic isocyanate. However, because this thermoplastic polyurethane material has a very large reactivity with isocyanates, making the reaction difficult to control, there have been a number of problems. For example, gelation tends to arise prior to use of the material in injection molding, making it impossible to ensure sufficient plasticity; gelation sometimes occurs during molding; and recycled resin cannot be reclaimed on account of gelation. These problems have made it difficult to put the art described in the above publication to practical use.

JP-B 58-2063 (Patent Document 14) and the corresponding U.S. Pat. No. 4,347,338 disclose a method of manufacturing thermoset polyurethane molded articles by intimately mixing a compound having two or more isocyanate groups with a thermoplastic resin that does not react with isocyanate groups, blending the resulting mixture with a thermoplastic polyurethane material, then feeding the blend to a molding machine and molding. However, the object of this published art is only to improve solvent resistance and resistance to repeated wear; these publications make no mention of the use of this molding material as a cover stock for golf balls. It is desired that golf ball cover materials be materials which satisfy the following properties required of golf balls: rebound, distance, spin properties, controllability, feel at impact, scuff resistance, cut resistance and resistance to discoloration.

JP-A 2002-336378 (Patent Document 15) describes a golf ball obtained using a cover stock composed of a thermoplastic polyurethane material and an isocyanate mixture. The cover stock is recyclable and is a thermoplastic polyurethane material having a high resilience and an excellent scuff resistance. This cover stock makes it possible both to achieve the good productivity of a thermoplastic polyurethane and to exhibit physical properties comparable with those of a thermoset polyurethane; at the same time, it enhances the flow properties of the thermoplastic polyurethane material due to the plasticizing effect by the isocyanate compound, and can thus improve productivity. Although this art is outstanding in the above respects, because burn contaminants arise due to direct charging of the isocyanate mixture into the molding machine and there is some variability in the compounding ratio owing to the use of dry blending, the uniformity is poor, giving rise to molding instability. At the same time, the compositional ratio between the isocyanate compound and the thermoplastic resin which is substantially non-reactive with isocyanate within the isocyanate mixture has already been set, and so one has less freedom of choice in the amounts and types of isocyanate compound and thermoplastic resin to be added.

JP-A 2002-336380 (Patent Document 16) describes a golf ball which uses, as the cover stock, a material obtained by compounding a thermoplastic polyurethane material that contains, as a polymeric polyol, a polyether polyol having an average molecular weight of at least 1500 and has a rebound resilience of at least 40% with a specific isocyanate mixture. However, as in the case of Patent Document 15 above, there are a number of undesirable effects, such as the generation of burn contaminants due to charging of the cover stock into the molding machine, the instability of molding, and also limitations on selection of the loadings and types of isocyanate compounds added.

To address these problems, JP-A 2008-049152 (Patent Document 17) and U.S. Pat. No. 8,182,367 (Patent Document 18) describe the formation of a cover by injection-molding pellets formulated from a thermoplastic polyurethane, another thermoplastic elastomer and a polyisocyanate. Golf balls in which the cover has been formed in this way are noted as having an excellent rebound, spin performance and scuff resistance. However, in order for the pellets to include some residual isocyanate compound on which there remain unreacted isocyanate groups, it is essential in this method for the pellets to be obtained by carrying out the kneading operation in an inert gas such as nitrogen or in a vacuum state. As a result, supply of the materials is not always easy. This approach is also disadvantageous in terms of production costs.

### SUMMARY OF THE INVENTION

It is therefore an object of the invention to provide a golf ball manufacturing method which, during the production of golf balls endowed with an excellent rebound and scuff resistance using as the cover stock a thermoplastic polyurethane material having excellent flowability and productivity, is capable of resolving problems with the ease of supplying the material and with production costs.

As a result of extensive investigations, the inventors have discovered that when a golf ball cover is injection-molded using both resin pellets of a first kind which are composed primarily of a thermoplastic polyurethane and a polyisocyanate compound mixed under conditions that maintain isocyanate groups in an unreacted state and also resin pellets of a second kind which are composed primarily of a thermoplastic polyurethane and contain no polyisocyanate compound, the amount in which resin pellets requiring preparation under special conditions are used is reduced, enabling effective improvements to be made in the ease of supplying the material and in production costs. Moreover, the inventors have found that because the cover is composed primarily of a thermoplastic polyurethane material that has excellent flow properties and can be injection molded at a good productivity, golf balls of excellent rebound and scuff resistance can be obtained.

Accordingly, the invention provides the following method of manufacturing a golf ball.

[1] A method of manufacturing golf balls having a core and a cover of one or more layer molded over and encasing the core, which method comprises forming at least one layer of the cover by dry blending:

one or more type of (i) resin pellets of a first kind obtained by kneading, in a nitrogen atmosphere, a low-humidity atmosphere having a moisture content of not more than 100 ppm or a vacuum atmosphere, a resin blend composed primarily of (A) a thermoplastic polyurethane and (B) a polyisocyanate compound, at least some of the isocyanate groups within the resin pellets remaining in an unreacted state; and

one or more type of (ii) resin pellets of a second kind composed primarily of (C) a thermoplastic polyurethane, then feeding the dry blend to an injection-molding operation.

[2] The golf ball manufacturing method of [1], wherein polyisocyanate compound in which all isocyanate groups on the molecule remain in an unreacted state is present in at least some portion of the polyisocyanate compound (B) within the first kind of resin pellet (i).
[3] The golf ball manufacturing method of [1], wherein preparation of the first kind of resin pellet (i) includes the step of, after kneading the resin blend, cooling the resin blend in a nitrogen atmosphere or a low-humidity atmosphere having a moisture content of not more than 100 ppm.
[4] The golf ball manufacturing method of [1], wherein the thermoplastic polyurethane (C) in the second kind of resin pellet (ii) is the same as component (A) in the first kind of resin pellet (i).
[5] The golf ball manufacturing method of [1], wherein isocyanate groups in an unreacted state are not present in the second kind of resin pellet (ii).
[6] The golf ball manufacturing method of [1], wherein the first kind of resin pellet (i) and the second kind of resin pellet (ii) have a compounding ratio therebetween of from 1/99 to 99/1.
[7] The golf ball manufacturing method of [1], wherein the first kind of resin pellet (i) and the second kind of resin pellet (ii) have a compounding ratio therebetween of from 25/75 to 75/25.
[8] The golf ball manufacturing method of [1], wherein the first kind of resin pellet (i) and the second kind of resin pellet (ii) have a compounding ratio therebetween of 50/50.
[9] The golf ball manufacturing method of [1], wherein (D) a thermoplastic elastomer other than a thermoplastic polyurethane is included in one or both of the first kind of resin pellet (i) and the second kind of resin pellet (ii).
[10] The golf ball manufacturing method of [1], wherein a single-screw or twin-screw extruder is used to knead the resin blend during preparation of the first kind of resin pellet (i).

### DETAILED DESCRIPTION OF THE INVENTION

The invention is described more fully below.

The golf ball manufacturing method of the invention, as described above, forms at least one layer of a golf ball cover by dry blending (i) resin pellets of a first kind prepared by kneading a thermoplastic polyurethane and a polyisocyanate as the primary ingredients under special conditions, with (ii) resin pellets of a second kind prepared by kneading a thermoplastic polyurethane as the primary ingredient under ordinary conditions, and injection-molding the dry blend.

The first kind of resin pellet (i) is based on a thermoplastic polyurethane, and is obtained by kneading a resin blend composed primarily of (A) a thermoplastic polyurethane and (B) a polyisocyanate compound.

First, the thermoplastic polyurethane (A) is described. The structure of the thermoplastic polyurethane includes soft segments composed of a polymeric polyol that is a long-chain polyol (polymeric glycol), and hard segments composed of a chain extender and a polyisocyanate compound. Here, the long-chain polyol serving as a starting material is not subject to any particular limitation, and may be any that is used in the prior art relating to thermoplastic polyurethanes. Exemplary long-chain polyols include polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. These long-chain polyols may be used singly or as combinations of two or more thereof. Of the long-chain polyols mentioned here, polyether polyols are preferred because they enable the synthesis of thermoplastic polyurethanes having a high rebound resilience and excellent low-temperature properties.

Illustrative examples of the above polyether polyol include poly(ethylene glycol), poly(propylene glycol), poly(tetramethylene glycol) and poly(methyltetramethylene glycol) obtained by the ring-opening polymerization of cyclic ethers. The polyether polyol may be used singly or as a combination of two or more thereof. Of the above, poly(tetramethylene glycol) and/or poly(methyltetramethylene glycol) are preferred.

It is preferable for these long-chain polyols to have a number-average molecular weight in the range of 1,500 to 5,000. By using a long-chain polyol having such a number-average molecular weight, golf balls which are made with a thermoplastic polyurethane composition and have excellent properties such as resilience and manufacturability can be reliably obtained. The number-average molecular weight of the long-chain polyol is more preferably in the range of 1,700 to 4,000, and even more preferably in the range of 1,900 to 3,000.

The number-average molecular weight of the long-chain polyol refers here to the number-average molecular weight computed based on the hydroxyl number measured in accordance with JIS K-1557.

A chain extender used in the prior art relating to thermoplastic polyurethanes may be suitably used in the present invention. For example, a low-molecular-weight compound which has a molecular weight of 400 or less and bears on the molecule two or more active hydrogen atoms capable of reacting with isocyanate groups is preferred. Examples of the chain extender include, but are not limited to, 1,4-butylene glycol, 1,2-ethylene glycol, 1,3-butanediol, 1,6-hexanediol and 2,2-dimethyl-1,3-propanediol. Of these chain extenders, aliphatic diols having 2 to 12 carbons are preferred, and 1,4-butylene glycol is more preferred.

The polyisocyanate compound is not subject to any particular limitation; preferred use may be made of one that is used in the prior art relating to thermoplastic polyurethanes. Specific examples include one or more selected from the group consisting of 4,4′-diphenylmethane diisocyanate, 2,4-toluene diisocyanate, 2,6-toluene diisocyanate, p-phenylene diisocyanate, xylylene diisocyanate, naphthylene-1,5-diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate and dimer acid diisocyanate. Depending on the type of isocyanate used, the crosslinking reaction during injection molding may be difficult to control. In the practice of the invention, to provide a balance between stability at the time of production and the physical properties that are manifested, it is most preferable to use 4,4′-diphenylmethane diisocyanate, which is an aromatic diisocyanate.

It is most preferable for the thermoplastic polyurethane serving as above component A to be a thermoplastic polyurethane synthesized using a polyether polyol as the long-chain polyol, using an aliphatic diol as the chain extender, and using an aromatic diisocyanate as the polyisocyanate compound. It is desirable, though not essential, for the polyether polyol to be a polytetramethylene glycol having a number-average molecular weight of at least 1,900, for the chain extender to be 1,4-butylene glycol, and for the aromatic diisocyanate to be 4,4′-diphenylmethane diisocyanate.

The ratio of active hydrogen atoms to isocyanate groups in the above polyurethane-forming reaction may be adjusted within a desirable range so as to make it possible to obtain golf balls which are made with a thermoplastic polyurethane composition and have various improved properties, such as rebound, spin performance, scuff resistance and manufacturability. Specifically, in preparing a thermoplastic polyurethane by reacting the above long-chain polyol, polyisocyanate compound and chain extender, it is desirable to use the respective components in proportions such that the amount of isocyanate groups included in the polyisocyanate compound per mole of active hydrogen atoms on the long-chain polyol and the chain extender is from 0.95 to 1.05 moles.

No particular limitation is imposed on the method of preparing the thermoplastic polyurethane used as component A. Preparation may be carried out by either a prepolymer process or a one-shot process which uses a long-chain polyol, a chain extender and a polyisocyanate compound and employs a known urethane-forming reaction. Of these, a process in which melt polymerization is carried out in a substantially solvent-free state is preferred. Production by continuous melt polymerization using a multiple screw extruder is especially preferred.

It is also possible to use a commercial product as the thermoplastic polyurethane serving as component A. Illustrative examples include Pandex T8295, Pandex T8290 and Pandex T8260 (all available from DIC Bayer Polymer, Ltd.).

Next, in the polyisocyanate compound used as above component B, it is essential for at least some of the isocyanate groups within the resin pellets (i) to remain in an unreacted state, and preferable for polyisocyanate compound in which all of the isocyanate groups on the molecule remain in an unreacted state to be present. The presence of both a polyisocyanate compound in which all the isocyanate groups on the molecule remain in an unreacted state and a polyisocyanate compound in which some of the isocyanate groups on the molecule remain in an unreacted state is also possible.

Various isocyanates may be used without particular limitation as this polyisocyanate compound. Illustrative examples include one or more selected from the group consisting of 4,4′-diphenylmethane diisocyanate, 2,4-toluene diisocyanate, 2,6-toluene diisocyanate, p-phenylene diisocyanate, xylylene diisocyanate, naphthylene-1,5-diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate and dimer acid diisocyanate. Of the above group of isocyanates, the use of 4,4′-diphenylmethane diisocyanate, dicyclohexylmethane diisocyanate and isophorone diisocyanate is preferable in terms of the balance between the influence on moldability of, e.g., the rise in viscosity accompanying the reaction with the thermoplastic polyurethane serving as component A and the physical properties of the resulting golf ball cover stock.

Although not an essential ingredient, in addition to components A and B, a thermoplastic elastomer other than the above-described thermoplastic polyurethane may be included in the first kind of resin pellet (i) as component D. By including this component D in the above resin blend, the flow properties of the resin blend can be further increased and improvements can be made in various properties required of a golf ball cover stock, such as resilience and scuff resistance.

The thermoplastic elastomer other than a thermoplastic polyurethane which serves as component D may be of one, two or more types selected from among polyester elastomers, polyamide elastomers, ionomeric resins, styrene block elastomers, hydrogenated styrene-butadiene rubbers, styrene-ethylene/butylene-ethylene block copolymers and modified forms thereof, ethylene-ethylene/butylene-ethylene block copolymers and modified forms thereof, styrene-ethylene/butylene-styrene block copolymers and modified forms thereof, ABS resins, polyacetals, polyethylenes and nylon resins. In particular, because they increase the resilience and scuff resistance due to reaction with isocyanate groups while at the same time maintaining a good productivity, the use of polyester elastomers, polyamide elastomers and polyacetals is especially preferred.

Suitable additives may be optionally included in the first kind of resin pellet (i). For example, known additives such as pigments, dispersants, antioxidants, light stabilizers, ultraviolet absorbers and mold release agents may be suitably included.

This first kind of resin pellet (i) is obtained by suitably adding the above additives to a resin mixture containing above components A, B and D. At this time, it is essential to select conditions such that polyisocyanate compound in which isocyanate groups remain in an unreacted state is present in at least some portion of the polyisocyanate compound. Specifically, it is essential to carry out kneading in a nitrogen atmosphere, a low-humidity atmosphere having a moisture content of not more than 100 ppm or a vacuum atmosphere. Also, although not subject to any particular limitation, subsequent to kneading under the above conditions, in order to more effectively induce the residual presence of unreacted isocyanate groups, it is preferable to carry out a cooling step that involves cooling in a nitrogen atmosphere or a low-humidity atmosphere having a moisture content of not more than 100 ppm. In addition, although not particularly limited, preferred use may be made of a single-screw or twin-screw extruder for kneading.

Next, the second kind of resin pellet (ii) is composed primarily of (C) a thermoplastic polyurethane. This thermoplastic polyurethane, although not particularly limited, is exemplified by the same thermoplastic polyurethanes as described above in connection with component A. In particular, the use of the same thermoplastic polyurethane as component A in the first kind of resin pellet (i) described above is preferred.

As in the above-described first kind of resin pellet (i), (D) a thermoplastic elastomer other than a thermoplastic polyurethane may be included in the second kind of resin pellet (ii). This component D is exemplified in the same way as component D in the first kind of resin pellet (i), and may be the same as or different from that used in the first kind of resin pellet (i). Moreover, as in the case with the first kind of resin pellet (i), known additives may be included in the second kind of resin pellet (ii).

A polyisocyanate compound is not included in the second kind of resin pellet (ii), and there is no need for isocyanate groups in an unreacted state to be present therein. Nor is there a need here, with regard also to the polyisocyanate compound used when preparing the thermoplastic polyurethane serving as component C, for the residual presence of isocyanate groups in an unreacted state.

The second kind of resin pellet (ii) is obtained by kneading a resin mixture which includes above components C and D and the above-mentioned additives. However, because there is no need for the residual presence of unreacted isocyanate groups in the second kind of resin pellet (ii), the kneading conditions are not subject to any particular limitation, enabling kneading to be carried out under ordinary conditions.

The first kind of resin pellet (i) and the second kind of resin pellet (ii) are dry blended, then fed to a cover injection-molding operation. In order for handling at this time to be easily and smoothly carried out, it is preferable to form the pellets to a length of about 1 to 10 mm and a diameter of about 0.5 to 5 mm.

The compounding ratio by weight of resin pellets (i) and (ii), although not particularly limited, is preferably from 1/99 to 99/1, more preferably from 25/75 to 75/25, and most preferably 50/50. It is possible also to use two or more types of the first kind of resin pellet (i) and two or more types of the second kind of resin pellet (ii).

The compounding ratios of components A, B, C and D in above resin pellets (i) and (ii) are not particularly limited, although it is desirable to adjust the compounding ratios in the respective kinds of pellets so that the compounding ratios in the mixture of resin pellets (i) and (ii), expressed as weight ratios, are preferably (A)+(C):(B):(D)=100:2 to 50:0 to 50, and more preferably (A)+(C):(B):(D)=100:2 to 30:8 to 50.

From the standpoint of increasing flowability and productivity, the cover-forming resin material obtained by blending above resin pellets (i) and (ii) has a melt mass flow rate (MFR) at 210° C. which, although not particularly limited, is preferably at least 5 g/10 min, and more preferably at least 6 g/10 min. If this melt mass flow rate is low, not only will the flowability decrease, possibly causing eccentricity during injection molding, the degree of freedom in the thickness of the cover that can be molded may decrease. The melt mass flow rate is a value measured in general accordance with JIS-K7210 (1999 edition).

The method of molding the cover layer is described. The cover layer can be molded by, for example, feeding to an injection-molding machine a cover-forming resin material obtained by uniformly dry blending the first and second kinds of resin pellets (i) and (ii) in the mixing ratio indicated above, then injecting the molten cover-forming resin material over the core. The molding temperature in this case differs according to the type of thermoplastic polyurethane, but is typically in the range of 150 to 250° C.

When injection molding is carried out, it is desirable, though not essential, to carry out such molding in a low-humidity environment by subjecting some or all places on the resin paths from the resin feed zone to the mold interior to purging with an inert gas such as nitrogen or a low-temperature gas such as low dew-point dry air, or to vacuum treatment. Preferred, non-limiting, examples of the medium used for transporting the resin under applied pressure include low-moisture gases such as low dew-point dry air or nitrogen gas. By carrying out molding in such a low-humidity environment, reactions by the isocyanate groups are kept from proceeding before the resin is charged into the mold interior. By thus including, within the resin molding, polyisocyanate in a form where some isocyanate groups are present in an unreacted state, it is possible to reduce variable factors such as an undesirable rise in viscosity and to increase the real crosslinking efficiency.

Techniques that may be used to confirm the presence of polyisocyanate compound in an unreacted state within the first kind of resin pellet (i) and within the cover-forming resin material prior to injection molding over the core include those which involve extraction with a suitable solvent that selectively dissolves out only the polyisocyanate compound. An example of a simple and convenient method is one in which confirmation is carried out by simultaneous thermogravimetric and differential thermal analysis (TG-DTA) measurement in an inert atmosphere. For example, when the first kind of resin pellet (i) or the cover-forming resin material is heated in a nitrogen atmosphere at a temperature ramp-up rate of 10° C./min, a gradual drop in the weight of diphenylmethane diisocyanate can be observed from about 150° C. On the other hand, in a resin sample in which the reaction between the thermoplastic polyurethane material and the isocyanate mixture has been carried out to completion, no drop in weight is observed from about 150° C., but a drop in weight can be confirmed from about 230 to 240° C.

After the cover-forming resin material has been injection-molded to form a cover as described above, the properties as a golf ball cover can be additionally improved by carrying out annealing so as to induce the crosslinking reaction to proceed further. “Annealing,” as used herein, refers to aging in a fixed environment for a fixed length of time.

In cases where the manufacturing method of the invention is employed to produce golf balls by forming a cover of one or more layer over a core, at least one cover layer is injection-molded from a cover-forming resin material which uses the above-described first and second kinds of resin pellets (i) and (ii). The cover layer molded from this cover-forming resin material has a surface hardness, expressed as the Durometer D hardness, of typically from 30 to 90, preferably from 35 to 85, more preferably form 40 to 80, and even more preferably from 45 to 75. If the surface hardness of the cover layer is too low, the spin rate on shots with a driver may increase, possibly lowering the distance traveled by the ball. On the other hand, if the surface hardness of the cover layer is too hard, the feel of the ball at impact may worsen, in addition to which the urethane stock may have an inferior resilience and durability. In this invention, “Durometer D hardness” refers to the hardness measured with a type D durometer in general accordance with JIS K7215.

The above cover layer has a rebound resilience which is typically at least 35%, preferably at least 40%, more preferably at least 45%, and even more preferably at least 47%. Because thermoplastic polyurethanes do not inherently have a particularly good resilience, exacting selection of the rebound resilience is preferred. If the rebound resilience of the cover layer is too low, the distance traveled by the golf ball may markedly decrease. On the other hand, if the rebound resilience of the cover layer is too high, on shots from a distance of within 100 yards that require control and on putts, the initial velocity may be too high and may not feel right to the golfer. As used herein, “rebound resilience” refers to the rebound resilience as measured in accordance with JIS K7311.

The core used in the manufacturing method of the invention is not particularly limited. For example, use may be made of the following various types of cores: solid cores for two-piece balls, solid cores having a plurality of vulcanized rubber layers, solid cores having a plurality of resin layers, and wound cores having a layer of rubber thread. Nor are there any limitations on, for example, the diameter, weight, hardness and material of the core.

In cases where the golf ball has a construction that includes an intermediate layer, no limitations are imposed on the hardness, material, thickness and other characteristics of the intermediate layer.

The cover layer has a thickness which is preferably in the range of 0.1 to 5.0 mm. As noted above, the cover is not limited to a single layer, and may be formed so as to have a multilayer structure of two or more layers. In cases where the cover is formed with a multilayer structure, the overall thickness of the cover may be set within the above-indicated range.

The golf ball obtained by the inventive method is preferably formed to a diameter and weight in accordance with the Rules of Golf. The golf ball is typically formed to a diameter of not less than 42.67 mm and a weight of not more than 45.93 g, although the diameter is preferably from 42.67 to 42.9 mm. Deflection by the ball when compressed under a load of 980 N (100 kg) is typically from 2.0 to 4.0 mm, with a deflection of from 2.2 to 3.8 mm being especially suitable.

The manufacturing method of the invention makes it possible to obtain golf balls having a high rebound and excellent spin performance and scuff resistance. Also, the cover-forming resin material composed of the above-described first and second kinds of resin pellets (i) and (ii) has a high flowability, resulting in a good golf ball productivity. In addition, by using the second kind of resin pellet (ii), it is possible to reduce the amount in which the first kind of resin pellet (i)—the preparation of which requires that a kneading operation be carried out under special conditions—is used, thus enabling effective improvements to be made in the case of material supply and in the high cost of production.

### EXAMPLES

Examples of the invention and Comparative Examples are given below by way of illustration, and not by way of limitation.

### Examples 1 to 5

### Formation of Core

Solid cores having a diameter of 38.5 mm for two-piece solid golf balls were obtained by kneading the core material having the formulation shown below, then molding and vulcanizing the material at 155° C. for 20 minutes. BR01, which is available from JSR Corporation, was used as the polybutadiene rubber. The resulting core had a specific gravity of 1.17 g/cm³, a deflection when compressed under a load of 980 N (100 kg) of 3.4 mm, and an initial velocity as measured in accordance with the USGA (R&A) measurement method of 78.1 m/s.

### Core Formulation

| | | |
|---|---|---|
| Polybutadiene rubber | 100 | parts by weight |
| Zinc acrylate | 24.5 | parts by weight |
| Zinc oxide | 12 | parts by weight |
| Dicumyl peroxide | 1 | part by weight |
| Zinc salt of pentachlorothiophenol | 1 | part by weight |

The starting materials shown in Table 1 (units: parts by weight) were each worked together in a twin-screw extruder under a nitrogen atmosphere, then cooled in a nitrogen atmosphere, giving the first kind of resin pellet (i) having a length of 4 to 5 mm and a diameter of 2 to 3 mm. In addition, the starting materials shown in Table 2 (units: parts by weight) were worked together in a twin-screw extruder in open air and at room temperature, giving the second kind of resin pellet (ii) having a length of 4 to 5 mm and a diameter of 2 to 3 mm.

TABLE 1
First Kind of Resin Pellet (i)

| | | Resin Pellet (i) | | | | |
|---|---|---|---|---|---|---|
| | | ia | ib | ic | id | ie |
| Thermoplastic | Polyurethane 1 | 100.0 | 100.0 | 100.0 | 100.0 | 0.0 |
| polyurethane | Polyurethane 2 | 0.0 | 0.0 | 0.0 | 0.0 | 100.0 |
| (pbw) | Polyurethane 3 | 0.0 | 0.0 | 0.0 | 0.0 | 0.0 |

| | | | | | |
|---|---|---|---|---|---|
| Polyisocyanate compound (pbw) | 18.0 | 19.4 | 18.8 | 19.7 | 19.4 |
| Elastomer (pbw) | 15.0 | 15.0 | 15.0 | 0.0 | 15.0 |
| Titanium oxide (pbw) | 3.5 | 3.5 | 0.0 | 3.5 | 3.5 |
| Ultramarine blue (pbw) | 0.4 | 0.4 | 0.0 | 0.4 | 0.4 |
| Polyethylene wax (pbw) | 1.5 | 1.5 | 1.5 | 1.5 | 1.5 |
| Montan wax (pbw) | 0.8 | 0.8 | 0.8 | 0.8 | 0.8 |

TABLE 2
Second Kind of Resin Pellet (ii)

| | | Resin Pellet (ii) | | | | | |
|---|---|---|---|---|---|---|---|
| | | iia | iib | iic | iid | iie | iif |
| Thermoplastic | Polyurethane | 100.0 | 100.0 | 100.0 | 100.0 | 100.0 | 0.0 |
| polyurethane | 1 | | | | | | |
| (pbw) | Polyurethane | 0.0 | 0.0 | 0.0 | 0.0 | 0.0 | 0.0 |
| | 2 | | | | | | |
| | Polyurethane | 0.0 | 0.0 | 0.0 | 0.0 | 0.0 | 100.0 |
| | 3 | | | | | | |

| | | | | | | |
|---|---|---|---|---|---|---|
| Elastomer (pbw) | 15.0 | 15.0 | 15.0 | 0.0 | 15.0 | 15.0 |
| Titanium oxide (pbw) | 3.5 | 3.5 | 6.7 | 3.5 | 3.5 | 3.5 |
| Ultramarine blue (pbw) | 0.4 | 0.4 | 0.8 | 0.4 | 0.4 | 0.4 |
| Polyethylene wax (pbw) | 1.5 | 1.5 | 1.5 | 1.5 | 1.5 | 1.5 |
| Montan wax (pbw) | 0.8 | 0.8 | 0.8 | 0.8 | 0.8 | 0.8 |

Details on the respective ingredients in Tables 1 and 2 are given below.

Polyurethane 1 (a thermoplastic polyurethane material)

“Pandex T8290” (available from DIC Bayer Polymer, Ltd.)

Polyurethane 2 (a thermoplastic polyurethane material)

“Pandex T8290” and “Pandex T8295” were used in a weight ratio of 50/50. Both are products of DIC Bayer Polymer, Ltd.

Polyurethane 3 (a thermoplastic polyurethane material)

“Pandex T8290” (available from DIC Bayer Polymer, Ltd.)
Explanation of “Pandex T8290”: An aromatic ether-type thermoplastic polyurethane material; resin hardness (JIS-A), 93; rebound resilience, 52%
Explanation of “Pandex T8295”: An aromatic ether-type thermoplastic polyurethane material; resin hardness (JIS-A), 97; rebound resilience, 44%

### Polyisocyanate Compound

4,4′-Diphenylmethane diisocyanate

### Elastomer

A thermoplastic polyether ester elastomer (“Hytrel 4001,” available from DuPont-Toray Co., Ltd.) was used.

### Polyethylene Wax

“Sanwax 161P” (from Sanyo Chemical Industries, Ltd.)

### Montan Wax

“Licowax E” (from Clariant (Japan) K.K.)

In each example, the above first and second kinds of resin pellets (i) and (ii) were dry blended in the weight ratios shown in Table 3, and the resulting blend was used as a cover-forming resin material. The solid core described above was placed in an injection mold, and the cover-forming resin material was injection-molded over the core, thereby giving the two-piece golf balls of Examples 1 to 5 having a cover with a thickness of 2.1 mm. The cover stock productivity was evaluated based on the following criteria. The results are shown in Table 3.

### Productivity Evaluation Criteria

Good: The molding conditions in mass production are stable, and problems such as resin burning do not often arise.
Poor: The molding conditions in mass production are unstable, and there is a high incidence of problems such as resin burning.

TABLE 3

| | | Example | | | | |
|---|---|---|---|---|---|---|
| Cover-forming resin material | | 1 | 2 | 3 | 4 | 5 |
| Resin pellets (i) | ia | 53.5 | | | | |
| (pbw) | ib | | 50.0 | | | |
| | ic | | | 50.0 | | |
| | id | | | | 50.0 | |
| | ie | | | | | 50.0 |
| Resin pellets (ii) | iia | 46.5 | | | | |
| (pbw) | iib | | 50.0 | | | |
| | iic | | | 50.0 | | |
| | iid | | | | 50.0 | |
| | iie | | | | | 25.0 |
| | iif | | | | | 25.0 |

Formulation of molded cover

| | | | | | | |
|---|---|---|---|---|---|---|
| Thermoplastic | Polyurethane 1 | 100.0 | 100.0 | 100.0 | 100.0 | 50.0 |
| polyurethane | Polyurethane 2 | 0.0 | 0.0 | 0.0 | 0.0 | 0.0 |
| (pbw) | Polyurethane 3 | 0.0 | 0.0 | 0.0 | 0.0 | 50.0 |

| | | | | | |
|---|---|---|---|---|---|
| Polyisocyanate compound (pbw) | 9.0 | 9.0 | 9.0 | 9.0 | 9.0 |
| Elastomer (pbw) | 15.0 | 15.0 | 15.0 | 0.0 | 15.0 |
| Titanium oxide (pbw) | 3.5 | 3.5 | 3.5 | 3.5 | 3.5 |
| Ultramarine blue (pbw) | 0.4 | 0.4 | 0.4 | 0.4 | 0.4 |
| Polyethylene wax (pbw) | 1.5 | 1.5 | 1.5 | 1.5 | 1.5 |
| Montan wax (pbw) | 0.8 | 0.8 | 0.8 | 0.8 | 0.8 |
| Productivity | good | good | good | good | good |

As shown in Table 3, when the manufacturing method of the invention is employed, the cover-forming resin material composed of the above-described first and second kinds of resin pellets (i) and (ii) has a high flowability, enabling golf balls endowed with excellent rebound, spin performance and scuff resistance to be manufactured at a high productivity. Moreover, by using the second kind of resin pellet (ii), it is possible to reduce the amount in which the first kind of resin pellet (i)—the kneading operation for which must be carried out under special conditions—is used, enabling effective improvements to be made in the ease of material supply and in the high cost of production.

1. A method of manufacturing golf balls having a core and a cover of one or more layer molded over and encasing the core, which method comprises forming at least one layer of the cover by dry blending:
one or more type of (i) resin pellets of a first kind obtained by kneading, in a nitrogen atmosphere, a low-humidity atmosphere having a moisture content of not more than 100 ppm or a vacuum atmosphere, a resin blend composed primarily of (A) a thermoplastic polyurethane and (B) a polyisocyanate compound, at least some of the isocyanate groups within the resin pellets remaining in an unreacted state; and
one or more type of (ii) resin pellets of a second kind composed primarily of (C) a thermoplastic polyurethane, then feeding the dry blend to an injection-molding operation.

2. The golf ball manufacturing method of claim 1, wherein polyisocyanate compound in which all isocyanate groups on the molecule remain in an unreacted state is present in at least some portion of the polyisocyanate compound (B) within the first kind of resin pellet (i).

3. The golf ball manufacturing method of claim 1, wherein preparation of the first kind of resin pellet (i) includes the step of, after kneading the resin blend, cooling the resin blend in a nitrogen atmosphere or a low-humidity atmosphere having a moisture content of not more than 100 ppm.

4. The golf ball manufacturing method of claim 1, wherein the thermoplastic polyurethane (C) in the second kind of resin pellet (ii) is the same as component (A) in the first kind of resin pellet (i).

5. The golf ball manufacturing method of claim 1, wherein isocyanate groups in an unreacted state are not present in the second kind of resin pellet (ii).

6. The golf ball manufacturing method of claim 1, wherein the first kind of resin pellet (i) and the second kind of resin pellet (ii) have a compounding ratio therebetween of from 1/99 to 99/1.

7. The golf ball manufacturing method of claim 6, wherein the first kind of resin pellet (i) and the second kind of resin pellet (ii) have a compounding ratio therebetween of from 25/75 to 75/25.

8. The golf ball manufacturing method of claim 7, wherein the first kind of resin pellet (i) and the second kind of resin pellet (ii) have a compounding ratio therebetween of 50/50.

9. The golf ball manufacturing method of claim 1, wherein (D) a thermoplastic elastomer other than a thermoplastic polyurethane is included in one or both of the first kind of resin pellet (i) and the second kind of resin pellet (ii).

10. The golf ball manufacturing method of claim 1, wherein a single-screw or twin-screw extruder is used to knead the resin blend during preparation of the first kind of resin pellet (i).
